(19) United States
(12) Patent Application Publication
(10) Pub. No.: US 2026/0273723 A1
(43) Pub. Date: Sep. 17, 2026

(54) ALL-TERRAIN ADJUSTABLE CREEPER

(71) Applicant: T&L DESIGN, LLC DBA AEROCREEPER, Corinne, UT (US)

(72) Inventors: Joel W. Hendrickson, Bear River City, UT (US); Travis L. Hendrickson, Bear River City, UT (US); Eliot Alpert, Lakewood, CO (US)

(73) Assignee: T&L DESIGN, LLC DBA AEROCREEPER, Corinne, UT (US)

(21) Appl. No.: 19/081,265

(22) Filed: Mar. 17, 2025

(51) Int. Cl. B25H 5/00

(52) U.S. Cl. CPC B25H 5/00

(57) ABSTRACT

An all-terrain adjustable creeper can include one or more rails, a seat slidably coupled to the one or more rails, a backrest rotatably coupled to the seat and the one or more rails to adjust between a raised position and a lowered position, and all-terrain wheels coupled to the one or more rails.

### FIELD

The described examples relate generally to adjustable creepers. In particular examples, the disclosure relates to an all-terrain adjustable creeper that is adjustable via manual actuation between raised and lowered positions.

### BACKGROUND

Creeper devices are widely used in repair shops and factories to allow an operator to lay in a low position to work underneath or around boats, automobiles, planes, or equipment. It is common to work at different heights relative to the subject equipment. Thus, adjustability of creepers can be desirable in many situations. However, some creepers are not adjustable and, instead, always lay flat or constantly in a lowered position. For creepers that are adjustable, the mode of adjustment typically involves one of two particular adjustment types. As a first type of adjustment, some creepers implement a powered solution (e.g., battery-powered operation, hydraulic powered operation, etc.). These powered creepers can be more complex, involve more moving parts, and thus introduce higher costs and more advanced assembly. The second type of adjustment is manual adjustment requiring user dismount. Specifically, these creepers can be manually adjusted, but the user cannot remain positioned on the creeper while any positional adjustment is performed. Rather, the user must get off the creeper to perform adjustment—lending to a poor user experience, bodily strain to compensate for poor positioning, and inefficient use of time and energy. Further, depending on the allotted workspace, a user may be physically incapable of getting off the creeper to adjust a height of the creeper—which leads to incompatibility for particular types of projects or incompatibility for some users.

Mobility, in addition to adjustability, can also impact the utility of a creeper. Indeed, users commonly roll the creeper around the vehicle or equipment to reposition where the creeper is located relative to the vehicle. This is easily done on smooth, clean shop floors and surfaces. However, most creepers are not suited for moving around on other surfaces (e.g., rocky surfaces, outdoor surfaces, in fields, on gravel roads, within dirt areas, through mud or sand, over vegetation and debris, across objects, etc.). Thus, creepers are largely limited to the shop environment and cannot be used to service equipment in an outdoor environment (e.g., dirt, gravel, grass, train yard, military base, or the like). Indeed, rail cars, trains, tractors, broken down or stranded vehicles, etc. are commonly positioned in an outdoor environment (and in certain cases, cannot be moved to a shop without painstaking efforts and expense). Farm and ranch operations, industrial operations, etc. (without limitation) often include working on vehicles and equipment in a non-shop or outdoor environment. Accordingly, there is an ongoing need for an improved creeper that is adjustable and can operate in various environments beyond a shop environment.

The subject matter claimed herein is not limited to examples that solve any disadvantages or that operate only in environments such as those described above. Rather, this background is only provided to illustrate one example technology area where some examples described herein may be practiced.

### SUMMARY

An aspect of the present disclosure relates to an adjustable creeper. In some examples, an adjustable creeper can include one or more rails, a seat slidably coupled to the one or more rails, a backrest rotatably coupled to the seat and the one or more rails to adjust between a raised position and a lowered position, and wheels coupled to the one or more rails.

In some examples, the wheels comprise all-terrain wheels with a diameter of at least 7 inches. In one or more examples, the adjustable creeper can include a footrest coupled to the one or more rails. In one example, in an unlocked configuration while the user is sitting on the seat, the seat can slide along one or more of the rails away from the footrest in response to a user pushing against the footrest. In one or more examples, the adjustable creeper can include a securement member to positionally lock and unlock the seat relative to the one or more rails. The one or more rails can include a plurality of receptacles, and the securement members can include a manual latch engageable with the plurality of receptacles. Each receptacle of the plurality of receptacles is spaced apart and corresponds to a seat position along with the one or more rails. In one or more examples, the backrest can raise as the seat slides backwards along the one or more rails, and the backrest can lower as the seat slides forward along the one or more rails. In one or more examples, the adjustable creeper can include a support coupled to an end portion of the one or more rails and positionable on a ground surface. In one or more examples, the support can be a caster wheel. The wheels can receive manual manipulation to maneuver the adjustable creeper.

In certain implementations, an adjustable creeper can include a fixed frame, front and rear ground supports coupled to the fixed frame, a seat translatable along the fixed frame, and an adjustable backrest coupled to the seat. In certain examples, the seat and the adjustable backrest can translate in tandem as the backrest raises and lowers to positionally control a center of mass between the front and rear ground supports.

In at least one example, to counteract a backward shifting of the center of mass that occurs when a user is progressively reclined in the adjustable creeper, the seat and the adjustable backrest translate forward in tandem to keep the center of mass positioned between the front and rear ground supports. In one or more examples, to counteract a forward shifting of the center of mass that occurs when a user is progressively uprighted in the adjustable creeper, the seat and the adjustable backrest translate backward in tandem to keep the center of mass closer to the rear ground support than the front ground support. In one or more examples, the rear ground support includes a pair of all-terrain wheels. In one or more examples, the center of mass accounts for a user positioned on the seat during adjustment. In one or more examples, the backrest is pivotally coupled to the seat at a lower backrest portion and pivotally coupled to the fixed frame at a mid-backrest portion.

Another aspect of the present disclosure relates to a manually adjustable creeper. The manually adjustable creeper can include a frame, front and rear ground supports coupled to the frame, a seat slidably coupled to the frame, and an adjustable backrest rotatably coupled to the seat. In some examples, at least one of the seat or the adjustable backrest are configured for manual user adjustment while a user remains positioned on the seat.

In at least one example, the manually adjustable creeper can further include a footrest coupled to the frame, wherein the manual user adjustment can include a user applying a bodily force to the footrest to push the seat and the adjustable backrest backward and raise the adjustable backrest. In one or more examples, the manual user adjustment includes a user applying a bodily force to push off the rear ground supports and at least partially unload the adjustable backrest, the adjustable backrest being spring-loaded to raise upward. In one or more examples, the manually adjustable creeper can include a hand lock that can positionally lock or unlock the seat relative to the frame, wherein the manual user adjustment includes a user applying a hand actuation to the hand lock.

Yet another aspect of the present disclosure relates to an all-terrain adjustable creeper. The all-terrain adjustable creeper can include: one or more rails, all-terrain wheels coupled to the one or more rails, a seat coupled to the one or more rails, and a backrest rotatable relative to the seat and adjustable between a raised position and a lowered position.

Other technical features may be apparent to one skilled in the art, having the benefit of this disclosure, in connection with the following figures, descriptions, and claims. Further, the subject matter claimed herein is not limited to embodiments that solve any disadvantages or that operate only in environments such as those described above. Rather, this summary section is only provided to illustrate certain feature and embodiments.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates an isometric view of an example creeper according to one or more examples of the present disclosure;

FIG. 1B illustrates an isometric view of the creeper shown in FIG. 1A in a lowered position;

FIG. 1C illustrates an isometric view of the creeper shown in FIG. 1A in a raised position;

FIG. 1D illustrates a rear isometric view of the creeper shown in FIG. 1C;

FIG. 2A illustrates a side view of the creeper shown in FIG. 1A in a raised position;

FIG. 2B illustrates a side view of the creeper shown in FIG. 1A in a lowered position;

FIG. 2C illustrates a side view of the creeper shown in FIG. 1A in a fully raised position;

FIG. 3A illustrates a bottom view of the creeper shown in FIG. 1A;

FIG. 3B illustrates a close-up perspective view of a manual latch of an example creeper in first position;

FIG. 3C illustrates a perspective view of the manual latch in FIG. 3B in a second position;

FIG. 4A illustrates a rear isometric view of an example user manipulation applied to the creeper shown in FIG. 1A;

FIG. 4B illustrates a rear isometric view of another example user manipulation applied to the creeper shown in FIG. 1A; and

FIG. 5 illustrates an isometric view of an example user interaction with the creeper shown in FIG. 1A.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

Certain embodiments of the following disclosure relate to an adjustable wheeled work chair (e.g., a creeper that can move between raised and lowered positions) that can be implemented in all-terrain environments. For example, the adjustable creeper of the present disclosure can include all-terrain wheels (e.g., enlarged wheels, rubber tires, outdoor tires, tires with tread or grip features, flexible wheels, surface conforming wheels, etc.). In this way, the adjustable creeper can be operational in outdoor environments and traverse many different types of ground surfaces such as sand, dirt, gravel, grass, or the like. The all-terrain wheels can also traverse different objects like railroad tracks, sticks, rocks, curbs, speed bumps, small steps, ledges, etc. The adjustable creeper of the present disclosure can thus be used to service a vast array of vehicles and equipment, regardless of their environment.

The all-terrain wheels of the disclosed adjustable creeper can also enable a variety of user inputs or user manipulations to maneuver the adjustable creeper, change creeper positions, add body support or stability, or exit the creeper. In one example, a user may rest their arms on the all-terrain wheels during operation (e.g., as an arm rest). In another example, the user can leverage the larger diameter of the all-terrain wheels to assist standing up out of the creeper. In yet another example, the user can grip and apply a bodily force (e.g., a push or pull of a user's hand) to the all-terrain wheel to rotate one or more of the all-terrain wheels— thereby inducing motion. In this way, the user can move the adjustable creeper along the ground by rotating the all-terrain wheels in a wheelchair fashion so that a user does not have to use their legs or get off the creeper to move.

The adjustable creeper of the present disclosure can also leverage a design that positionally controls a center of mass in relation to front and rear wheels (e.g., to maintain balance and/or stability). For example, the adjustable creeper of the present disclosure can include a seat translatable along a frame, in addition to an adjustable backrest coupled to the seat. The seat and the adjustable backrest can translate in tandem as the backrest raises and lowers to counteract the shifting center of mass of the user that occurs when the user changes body positioning. Accordingly, the seat and the adjustable backrest move cooperatively relative to the frame to positionally control the center of mass between the front and rear ground supports (e.g., wheels, feet, pegs, posts, etc.). Specifically, in any position from a lowered position to a fully raised position, the center of mass can be positioned such that the weight of the user is appropriately distributed to the wheels—thus avoiding instability (e.g., a forward and/or backward tilt of the adjustable creeper). For example, as the adjustable backrest raises, the seat and the adjustable backrest can translate backwards together toward the rear wheels so that the center of mass does not shift too far forward when the user begins to sit more upright. In another example, as the adjustable backrest lowers, the seat and the adjustable backrest can translate forward together toward the forward wheel so that the center of mass does not shift too far backward when the user begins to lay back and approach a more supine position.

Furthermore, in some examples, the center of mass is maintained at or near (e.g., within a threshold distance of) the axle of one or more of the all-terrain wheels. The proximity of the center of mass relative to the axle can, for example, enable the adjustable creeper to easily pivot (e.g., swivel, turn, or spin) on the all-terrain wheels for convenient, ergonomic maneuverability of the adjustable creeper while a user is positioned thereon. In certain examples, this proximity of the center of mass to the axle can be maintained independent of creeper positioning between a raised position and a lowered position because of the ability of the seat and backrest to move forward and backward together along the frame of the creeper simultaneously to the backrest raising and lowering. That is, the position of the adjustable creeper (whether raised or lowered) does not affect the ease of maneuvering the creeper.

Further, the disclosed creeper embodiments can raise and lower via manual actuation as the user remains stationed on the adjustable creeper. The user need not get off the adjustable creeper to perform any adjustment. This innovation has heretofore never been achieved using manual actuation. Conventionally, only hydraulic or battery-powered creepers in the art have previously enabled a user to remain on a creeper while raising or lowering the creeper. In contrast, the adjustable creeper of the present disclosure can be manually adjusted between raised and lowered positions while the user remains seated on the creeper—lending to improved ergonomics and ease of use over conventional manual creepers that require a user to get off the creeper to perform a manual adjustment.

There are several features that can contribute to the manual adjustability of the disclosed creeper. For example, the creeper can include one or more rails that can include a plurality of receptacles (e.g., apertures, notches, lock holes, position holders, or other engagement mechanisms). The creeper can include a manual latch that can engage with the plurality of receptacles. The manual latch can be hand operated via a lever, knob, dial, button, switch, etc. that, when operated, causes the manual latch to engage and/or disengage from one or more receptacles. In particular examples, each receptacle of the plurality of receptacles is spaced apart and corresponds to a seat position along the one or more rails. In one example, a user can apply a hand actuation to pivot the manual latch from out of a given receptacle so that the user can freely slide the seat forward or backward along the one or more rails to a desired position. At the desired position, the user can release the manual latch (e.g., for a spring-return latch) or otherwise perform a hand actuation to actively re-engage the manual latch with one or more receptacles on the frame and thus positionally lock the seat and backrest in place.

The disclosed creeper can further include a footrest coupled to the one or more rails (e.g., at a front-end portion of the frame). The user can use the footrest in different ways, such as a support that upholds a user's feet off the ground, a body stabilizer, and/or push-pull block. To illustrate, a user can disengage the manual latch and apply a bodily force via user feet to the footrest to push the seat and the adjustable backrest backward to raise the adjustable backrest. In one or more examples, the footrest can be used to assist the user to slow the seat as it translates along the one or more rail as the user lowers the backrest position. Still, in other examples, the footrest can be used to draw the seat forward when a user hooks their feet against the footrest and pulls the user forward.

Certain embodiments of the disclosed adjustable creeper can also include a spring-loaded backrest. The spring-loaded backrest can be biased to return the backrest to an at least partially raised position. In certain examples, the spring-loaded backrest can assist a user in changing from a lowered position by biasing the backrest upwards and away from the ground surface. In at least one example, as a user begins to lean forward, push off the all-terrain wheels, or otherwise at least partially unload the backrest, the backrest can automatically return upright and/or push against the user's back as the user orients their body away from the supine position. In some examples, the mechanical advantage of the spring force can provide a perceivable benefit in reducing the amount of user effort to change from a lowered position to a raised position.

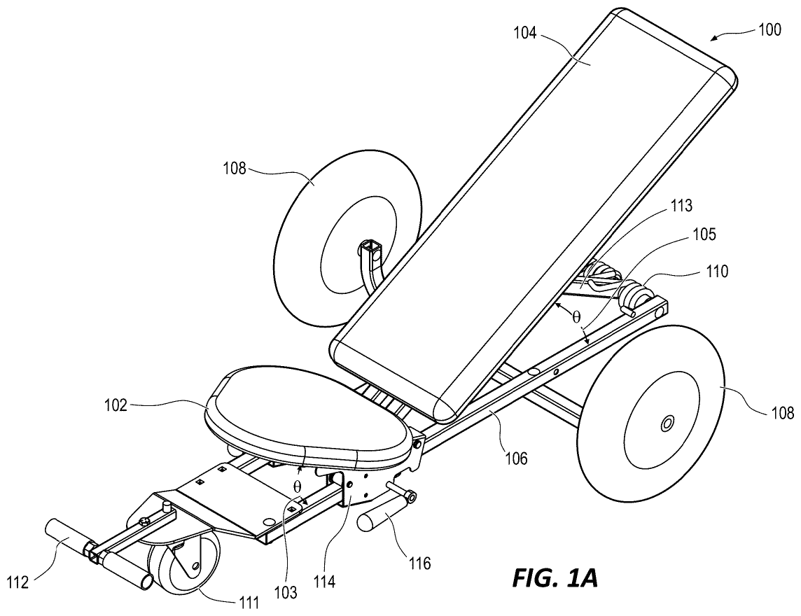

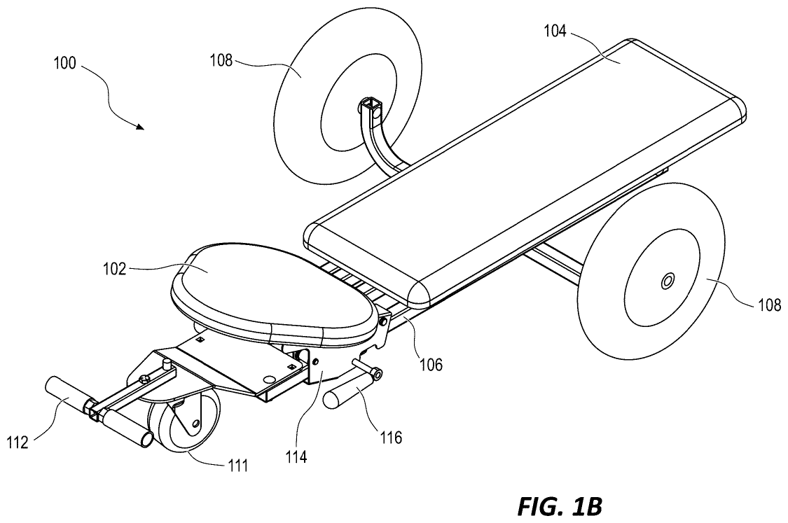

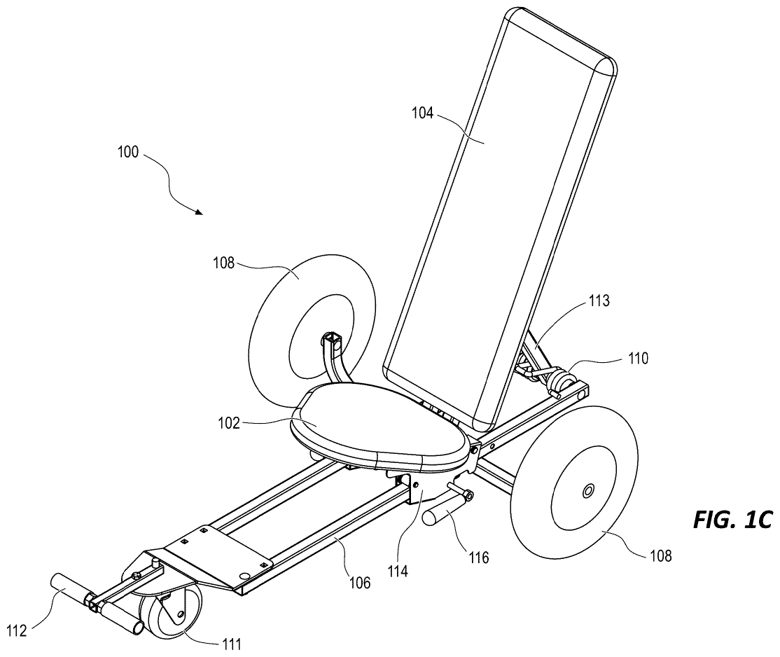

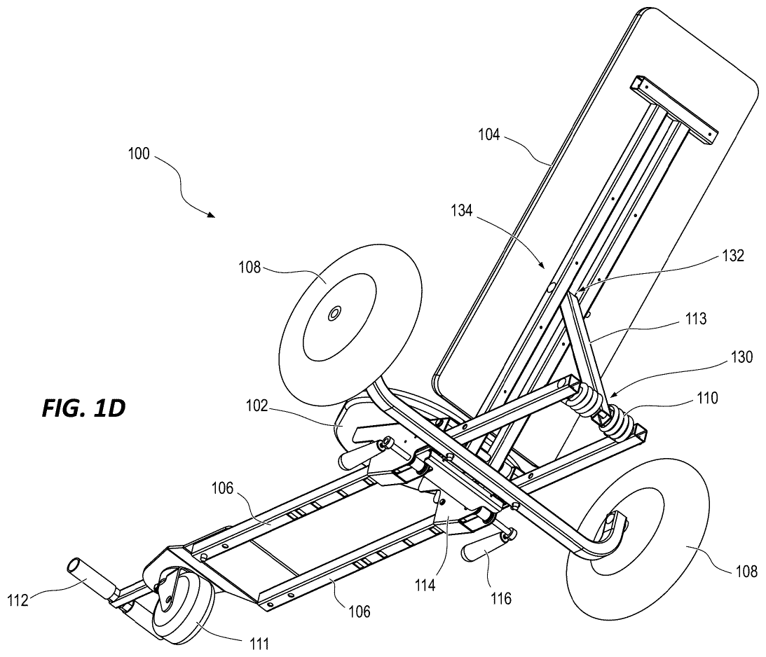

These and other examples are discussed below with reference to FIGS. 1-5. However, a person of ordinary skill in the art—having the benefit of this disclosure—will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A-1D respectively illustrate isometric views of an all-terrain adjustable creeper (hereafter, “creeper”) in accordance with one or more examples of the present disclosure. As shown, a creeper 100 includes a seat 102, a backrest 104, and a frame 106. As used herein, the term “seat” refers to a lower body support (e.g., for sitting thereon). In some examples, a seat can include a solid surface or a rigid backing (e.g., to help maintain structural integrity as well as support the weight of a user). In at least some examples, a seat is sized, shaped, and/or contoured to contact the glutes or upper hamstrings of a user. In particular examples, a seat includes a cushioned layer, such as a foam layer and/or upholstery layer, positioned over a rigid backing (e.g., to help provide increased comfort).

The seat 102 and the backrest 104 can adjust relative to the frame 106. In particular examples, the seat 102 and the backrest 104 adjust together in a coordinated fashion. Indeed, and as will be discussed below, the seat 102 can move forward and backward along the frame 106 as the backrest 104 changes its angle of inclination. For instance, the seat 102 can slide or translate along the frame 106. Additionally or alternatively, motion of the seat 102 can be geared, bounded, tracked, slotted, and/or guided by the frame 106.

In these or other examples, the seat 102 is positioned at a fixed height or angle 103 relative to the frame 106. The present disclosure is not so limited though. In some examples, the angle 103 can be adjusted in a variety of ways. For example it may be adjustable such that the seat 102 is pivotable to lay flat against the frame 106 or articulatable upwards for an increased pitch relative to the frame 106. In some examples, the seat can be articulatable via a cam actuation, a cam roller engagement with one or more support legs, etc. In another example, the seat can articulate via a linkage system. As discussed in more detail below, the angle of the seat 102 can provide and/or induce ergonomic support/positioning of the user's legs while the user rests their feet on a footrest (e.g., footrest 112). In certain examples, the seat 102 is positioned at the angle 103 relative to the frame 106 that coincides with an angle (or range of angles) that help to prevent the user from sliding off of the seat 102 as the backrest 104 moves between various positions and helps to comfortably maintain the user's body in a proper body position. In one or more examples, the angle 103 comprises a fixed angle of approximately 10 to 25 degrees, approximately 12 to 20 degrees, or approximately 15 to 18 degrees relative to the frame 106.

Additionally, in certain examples, the backrest 104 is also adjustable. For example, the backrest 104 can raise and lower in height relative to the frame 106. Additionally, the backrest 104 can articulate or pivot relative to the seat 102 to adjust an angle of inclination 105 measured relative to the frame 106. Indeed, as depicted in FIGS. 1A-1C, the backrest 104 is rotatable to different orientations that correspond to a partially raised or intermediate position (FIG. 1A), a lowered position (FIG. 1B), and a fully raised position (FIG. 1C).

As used herein, the term “backrest” refers to an upper body support (e.g., for laying back thereon). Like a seat, a backrest can include a solid surface or rigid backing. In certain cases, a backrest can additionally include a cushioned layer and/or upholstery layer. A backrest can also be sized, shaped, and/or contoured to contact a back of a user (e.g., along any length or portion from the waist up to the head of a user). In some examples, a detachable head rest can be removed and reattached to the backrest (e.g., via a strap, fastener, or mechanical connection), as may be desired. Alternatively, the backrest can include a built-in or permanently attached headrest.

Beneath the seat 102 and the backrest 104 lies the frame 106. As used herein, the terms “frame” or “fixed frame” refer to a support structure or carriage that maintains the creeper 100 above a ground surface. The frame 106 can thus include various fixed supports, posts, axles, chassis members, and the like. As illustrated in FIGS. 1A-1D, the frame 106 can include one or more rails (e.g., a central rail or a pair of rails). As discussed in more detail below, the one or more rails can include receptacles that can interact with securement members to adjust (and positionally secure in place) the seat 102 and backrest 104.

In particular examples, the creeper 100 is a movable or rollable creeper. In such a case, the frame 106 can include wheels 108, thereby allowing the frame 106 (and therefore the creeper 100) to roll across a ground surface. Although the creeper 100 is shown in a 3-wheel configuration, other configurations are herein contemplated (e.g., two front wheels and a single rear wheel, 4 wheels with two in the front and two in the back, etc.). However, in a 3-wheel configuration, the creeper 100 can provide improved stability and ease of movement (e.g., pivoting) compared to certain conventional creepers having more than 3 wheels. Alternatively, some examples of the creeper 100 can implement two all-terrain wheels on the rear and no wheels in the front (instead using a fixed support post in place of a wheel). Still, in other examples, the creeper 100 can implement no wheels at all—instead utilizing a continuous track or tracked treads.

In these or other examples, the wheels 108 can provide increased creeper mobility underneath and around objects within a workspace. Myriad diverse types of wheels can be implemented. In one particular example, the wheels 108 can be all-terrain wheels (e.g., enlarged wheels, rubber tires, outdoor tires, tires with tread or grip features, flexible wheels, surface conforming wheels, etc.). In this example, the all-terrain wheels can have a diameter of at least 7 inches. In this way, the wheels 108 can have the needed diameter to roll across different surfaces and objects without impeding wheel rotation. Additionally, the wheels 108 as all-terrain tires can provide additional clearance for the frame 106 (and therefore the creeper 100) to traverse across dirt, sand, gravel, snow, ground objects, or the like without becoming high-centered or stuck in the terrain. The all-terrain tires with a larger diameter can also include an increased surface area to prevent the wheels 108 from sinking into the outdoor ground surface. Although the all-terrain wheels are larger in diameter, they can still allow the creeper 100 to be low enough relative to the ground to work under equipment (e.g., airplanes, trackers, or the like). For example, the frame 106 (e.g., the axle and rails) can be recessed or dropped relative to the center axis of the wheels 108—thereby lowering the overall height profile of the creeper 100. In some examples a dropped or recess axle allows larger wheels but maintains a lower height profile of the creeper 100.

In specific implementations, the creeper 100 can include a support 111. In these examples, the support 111 can include caster wheels (e.g., swivel caster wheels with automatic and/or manual locking capability). In certain implementations, the support 111 include hollow kingpin caster wheels attached to the frame 106 via button head bolts (e.g., to reduce a profile height from component stacking and provide a lower profile for the creeper 100). In specific implementations, the support 111 can include an all-terrain caster wheel. The all-terrain caster wheel can be a larger caster wheel compared to a conventional caster wheel. In at least one example, the all-terrain caster can include treading to assist the all-terrain caster to have traction on outdoors ground support (e.g., dirt, sand, grass, or the like). Therefore, the all-terrain caster and all-terrain wheels can support and move the creeper 100 around outdoor environments that conventional creepers cannot traverse.

In one or more examples, the support 111 can include a fixed support (e.g., a support post, prop, strut, pole, stand, etc.) that extends orthogonally downward from the frame 106 to contact the ground. In this way, the creeper 100 can be supported in a stationary position when the support is contacting the ground to hold a user in a position. As discussed in more detail in regard to FIG. 8, the user can lean backwards while seated in the creeper 100 so as to raise the support 111 from the ground and then use their legs as movable front supports to maneuver the creeper 100. The support 111 and the wheels 108 can be referred to as front and rear ground supports, respectively (where the term “ground support” includes supports of all types—including fixed supports, movable supports, rollable supports, etc.). In certain examples, the front and rear ground supports can both include wheels. In another example, just the rear ground support includes a pair of wheels (e.g., all-terrain wheels) and the front ground support includes a fixed support. The support 111 is not limited to front and rear ground supports, however. Many different combinations and configurations of supports can be implemented. In one example, the support 111 can include multiple discrete supports at different locations of the creeper 100. For instance, the creeper 100 can implement two, three, or more supports (e.g., caster wheels) to enhance stability, prevent rocking of the apparatus, etc.

In one or more examples, and as particularly shown in FIG. 1D, the creeper 100 can further include a backrest support 113. The backrest support 113 can rotatably couple the backrest 104 to the frame 106. In some examples, the backrest support 113 can be biased away from the frame 106, thus inducing a spring force that tends to increase (or promote the increase of) the angle of inclination 105. In one or more examples, a bottom portion 130 of the backrest support 113 can rotate relative to the frame 106 to raise and lower the backrest 104. Additionally, a top portion 132 of the backrest support 113 can pivot in place relative to the backrest 104. In certain examples, the top portion 132 of the backrest support 113 is rotatably coupled to a mid-back portion 134 of the backrest 104 (e.g., via a spindle, dowel rod, etc.). Alternatively, in some examples, the top portion 132 of the backrest support 113 can be slidably coupled to the backrest 104 (e.g., to slide up and down the length of the backrest 104 as the backrest 104 raises and lowers). In this alternative example, as the backrest support 113 rotates about the frame 106, the backrest support 113 can slide down (e.g., toward the seat 102) the backrest 104 as the backrest 104 raises and the backrest support 113 can slide up (e.g., away from the seat 102) as the backrest 104 lowers.

As mentioned above, the backrest support 113 can be a biased support member. Accordingly, in one or more examples, the creeper 100 can further include a spring 110 coupled to the frame 106 and the backrest support 113. In this example, the spring 110 can assist the backrest support 113 in returning the backrest 104 to a raised position. In one example, the spring 110 can be a torsion spring. However, other springs are herein contemplated. For example, the spring 110 can include compression springs, tension springs, leaf springs, disc springs, flat springs, magazine springs, barrel springs, volute springs, helical springs, conical springs, coil springs, etc. Additionally or alternatively, the spring 110 can include gas springs, air springs, etc. Still, in other examples, the spring 110 can include manual actuators (e.g., hydraulic systems, pumps, pneumatic systems, and the like).

In one or more examples, the creeper 100 can further include a footrest 112. The footrest 112 can be coupled to the frame 106 on a front end portion of the creeper 100, as illustrated in FIGS. 1A-1D. As illustrated in FIGS. 1A-1D, the footrest 112 can include a set of pegs extending outward from the frame 106 for a user to rest their feet on. In other examples, the footrest 112 can be a platform, plate, stirrup, foot holder, leg cushion, or the like for a user to rest their feet/legs on. As discussed in more detail below, the user can apply a bodily force via their feet to adjust the seat 102 and backrest 104. In this way, the footrest 112 can serve as a fixed anchor that the user can leverage for providing a normal force (opposite the direction of leg push) in the direction of desired seat translation. Additionally or alternatively, the footrest 112 can provide a support to the user and maintain the user's feet off the ground surface as the user moves the creeper 100.

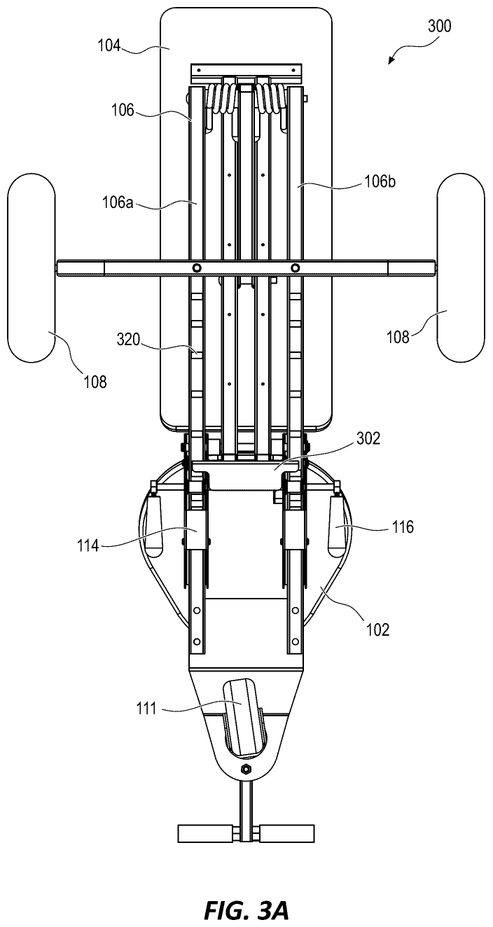

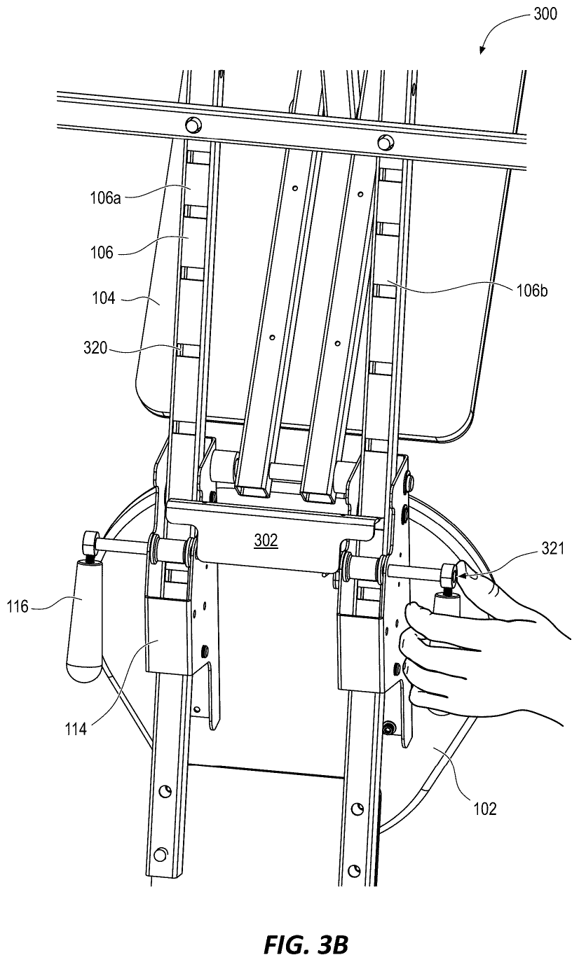

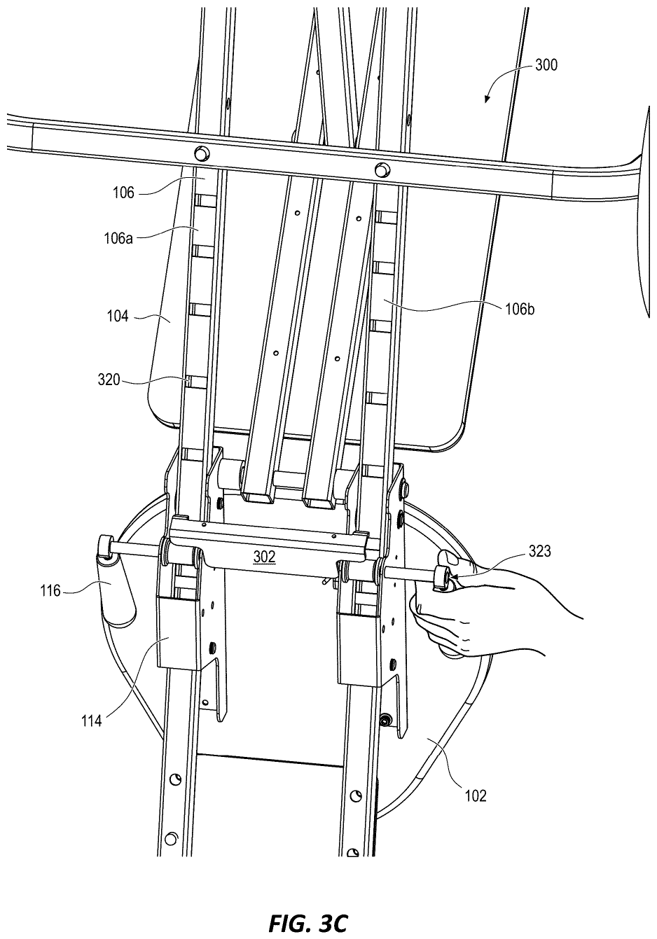

In one or more examples, the creeper 100 can further include a securement member 114. The securement member 114 can secure the seat 102 to the frame 106. For example, the securement member 114 can slidably couple the seat 102 to the frame 106 (e.g., via one or more guide rollers shown in FIG. 3B). In particular examples, the securement member 114 can positionally lock and unlock the seat 102 relative to the frame 106. In these or other examples, the securement member can include a manual latch (e.g., manual latch 302 shown in FIGS. 3A-3C). As discussed in more detail below in regard to FIGS. 3, 6A, and 6B, the securement member 114 can engage and disengage with receptacles defined by the frame 106 via the manual latch 302 to positionally lock and unlock the seat 102. The securement member 114 can include a hand lock 116 (e.g., a handle, lever, push button, knob, switch, slider, toggle, or other actuator mechanism) that can be manually actuated by a user to engage and disengage the manual latch to selectively allow sliding adjustment of the seat 102 relative to the frame 106. The hand lock 116 can be positioned on one side or both sides of the frame 106. In one or more examples, the user can rotate the hand lock counterclockwise or clockwise to engage and/or disengage the securement member 114 to the frame 106.

Modifications, additions, omissions, etc. of the various features described above can be implemented. For example, in some embodiments, the creeper 100 can implement all-terrain wheels, but not necessarily a sliding seat. For instance, the creeper 100 can implement all-terrain wheels supporting a fixed frame (e.g., rails) and a fixed seat with a pivotable backrest that can raise or lower relative to the fixed seat. In other embodiments, the creeper 100 can implement the various features discussed above, but not all-terrain wheels or enlarged wheels that exceed 5 to 7 inches in diameter. Indeed, many different various of the foregoing are herein contemplated.

Any of the features, components, and/or parts, including the arrangements and configurations thereof shown in FIGS. 1A-1D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1A-1D.

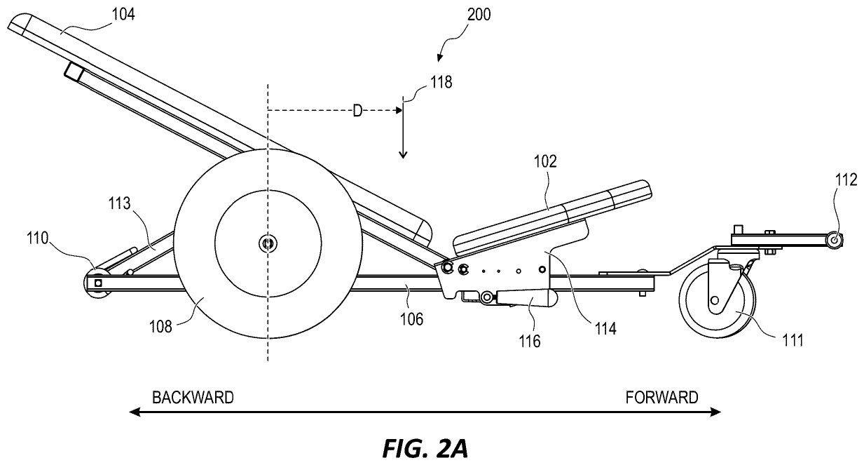

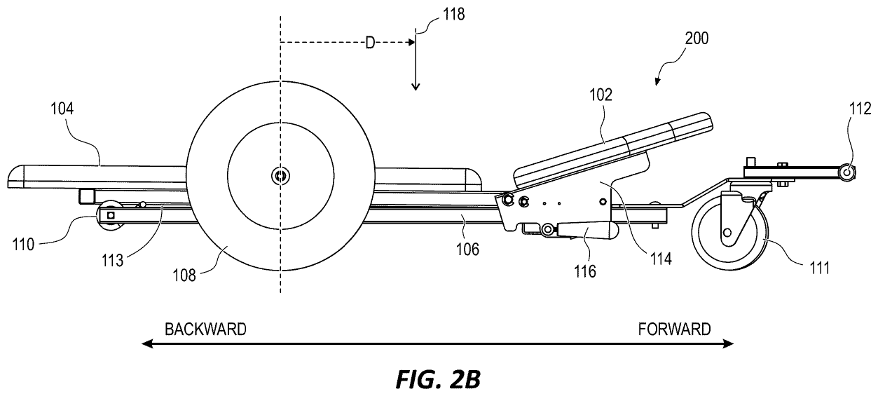

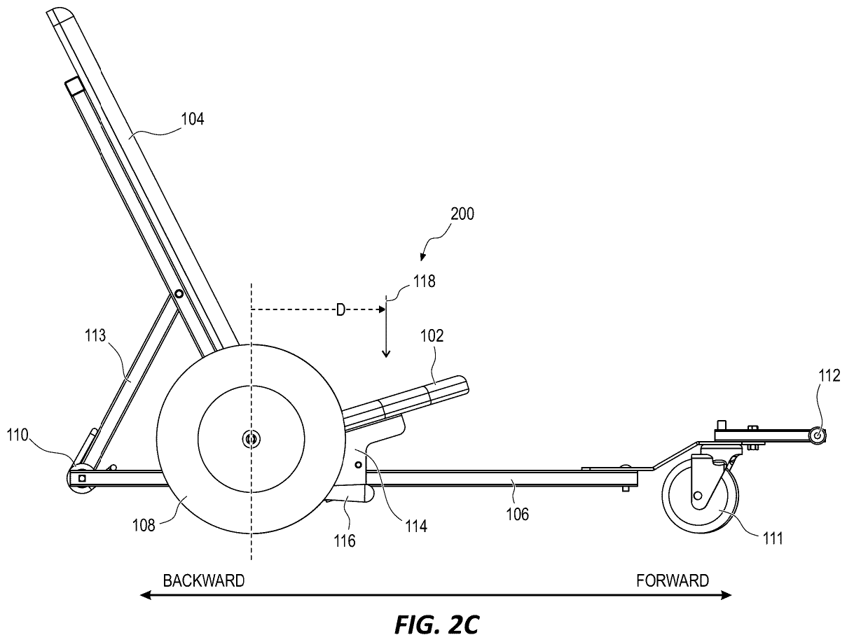

FIGS. 2A-2C illustrate side views of one example of a creeper 200 in various positions. The creeper 200 can be the same as or similar to the creeper 100 discussed above. In particular, the creeper 200 can include a frame 106, a seat 102 movably coupled to the frame 106, and a backrest 104 rotatably coupled to the seat 102. In one or more examples, the seat 102 can move (e.g., slide, incrementally reposition, step, or otherwise advance) along the frame 106 in forward and backward directions. In specific implementations, the seat 102 and the backrest 104 can translate or slide along the frame 106 in tandem (e.g., simultaneously) as the backrest 104 raises and lowers to positionally control a center of mass 118 between the wheels 108 and the support 111. The center of mass 118 as used herein can account for a user positioned on the seat 102 during adjustment of the seat 102 and backrest 104. Because a user's center of mass changes as their body position changes (e.g., between a supine position when the creeper is lowered and a sitting position when the creeper is raised), positionally controlling the center of mass 118 can affect a stability of the creeper 200, maneuverability, and the overall user experience.

As illustrated in FIG. 2A, the creeper 200 is in a partially raised position (or partially lowered position). From this intermediate positioning, the creeper 200 can recline further to the fully lowered position (shown in FIG. 2B) or raise further to the fully raised position (shown in FIG. 2C). As mentioned above, causing a user's body to recline, upright, and change between inherently induces positional changes in the user's center of mass. For example, a user's center of mass is relatively farther back when reclined than when seated upright. To compensate for these positional changes in the user's center of mass, both the seat 102 and the backrest 104 can be slidably manipulated to control where the center of mass is located relative to the creeper 200. For example, the seat 102 and the backrest 104 can translate backward (e.g., toward the wheels 108) in tandem as the backrest 104 is raised, thus counteracting the forward shifting of the user's center of mass. By contrast, the seat 102 and backrest 104 can translate forward to counteract the backward shifting of the user's center of mass. FIGS. 2B and 2C are illustrative of this counteracting effect. For example, the center of mass 118 in each of FIGS. 2A-2C is positioned at a distance D (measured from the rotational axis of the wheels 108) that is approximately constant regardless of whether the creeper is raised, lowered, or positioned somewhere in between these positions. Therefore, the creeper 200 can remain positionally stable and be easily pivoted and maneuvered by the user regardless of creeper position.

In more detail, and as illustrated in FIG. 2B, the seat 102 and the backrest 104 can be moved to a lowered position. In comparison to FIG. 2A, the seat 102 and backrest 104 are slid positionally forward. The forward translation of the seat 102 and the backrest 104 has compensated for the user's backward shifting center of mass induced by the user being reclined in the creeper 200. This positional compensation is pictorially reflected in the distance D of FIG. 2B being approximately the same as the distance D shown in FIG. 2A.

As illustrated in FIG. 2C, the seat 102 and the backrest 104 are in a fully raised or fully upright position. In comparison to both FIGS. 2A and 2B, the seat 102 and backrest 104 are slid positionally backward. The backward translation of the seat 102 and the backrest 104 has compensated for the user's forward shifting center of mass induced by the user being uprighted in the creeper 200. This positional compensation is pictorially reflected in the distance D of FIG. 2C being approximately the same as the distance D shown in FIGS. 2A and 2B.

In these or other examples, the distance D between the center of mass 118 and the rotational axis of the wheels 108 can be a variety of distance values and/or within a range of distance values. In some examples, the distance D is approximately 1 inch to about 50 inches, about 3 inches to about 40 inches, about 6 inches to about 24 inches, or about 12 inches to about 20 inches. In certain examples, the distance D is approximately zero—in which case the center of mass 118 is dead center over the rotational axis of the wheels 108.

Further, those of ordinary skill in the art, having the benefit of this disclosure, will appreciate that the distance D need not be constant (or even approximately constant) between the different positional configurations of the creeper 200 shown in FIGS. 2A-2C. Certain positional configurations of the center of mass can prioritize certain stability attributes, maneuverability attributes, etc. in different ways or to different degrees. For example, in certain implementations, the distance D can be relatively greater (thus placing the center of mass more forward) in the lowered position to prioritize stability (e.g., anti-tilting) by more evenly distributing weight to both front and rear wheels. As another example, the distance D can be relatively smaller (thus placing the center of mass further back) in the raised position to more easily maneuver the creeper 200 while positioned upright. In some examples, a smaller distance D can allow a user to more rapidly perform more macro movements or pivot rotations (or intentionally allow backward tilting to traverse large objects or roll exclusively on the wheels 108) by keeping the center of mass 118 closer to the axis of rotation for the wheels 108.

In one or more examples, the seat 102 and the backrest 104 can be translated in tandem from the lowered position (as illustrated in FIG. 2B), to a raised position (as illustrated in FIG. 2A), to a fully raised position (as illustrated in FIG. 2C) via manual user adjustments. The user can apply a bodily force (e.g., via the feet) to the footrest to push the seat 102 and the backrest 104 to raise the backrest 104 as the securement member 114 is disengaged. In this way, the height of the backrest 104 can be adjusted while the user is positioned on the creeper 200. Therefore, the user does not need to get off of the creeper 200 to adjust the height of the backrest 104.

Any of the features, components, and/or parts, including the arrangements and configurations thereof shown in FIGS. 2A-2C can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIGS. 2A-2C.

FIG. 3A illustrates a bottom view of one example of a creeper 300 that can include a frame 106. The creeper 300 can be the same as or similar to the creepers 100, 200 discussed above. The frame 106 can include one or more rails. As illustrated in FIG. 3, the frame 106 can include a pair of rails, namely rails 106a, 106b. The rails 106a, 106b can include a plurality of receptacles 320. The plurality of receptacles 320 can extend along at least a portion of the length of the rails 106a, 106b.

In some examples, the plurality of receptacles 320 can include a spacing between each other to provide a corresponding resolution of creeper adjustment. In some examples, the spacing between receptacles can vary, depending on location relative to the rails 106a, 106b. For example, the spatial distance between each receptacle of the plurality of receptacles 320 can progressively decrease in the forward direction and progressively increase in the backward direction (as directionally notated in FIGS. 2A-2C). In at least one example, the receptacle spacing along the rails 106a, 106b is smallest near a front portion of the rails 106a, 106b that is closest to support 111. In certain examples, the receptacle spacing varies based on the corresponding amount of angular adjustment to the angle of inclination 105. For example, the angle of inclination 105 can change faster (for a given amount of linear seat translation along the rails 106a, 106b) when initially transitioning from the lowered position than when initially transitioning from the fully raised position. Each receptacle of the plurality of receptacles 320 can correspond to a seat position along the rails 106a, 106b.

As mentioned above, the creeper 300 can include a securement member 114 that includes a manual latch 302. The manual latch 302 can include a variety of features to engage (e.g., lock, catch, hook, clip, fasten, intermesh, insert, removably couple, etc.) with the rails 106a, 106b. In some examples, the manual latch 302 can include a pivoting latch (e.g., with protrusions extending from the securement member 114 that can retract in and out of the receptacles)—thereby engaging with the plurality of receptacles 320. The protrusions of the manual latch 302, for example, can be bounded or held in place by the portions of the rails 106a, 106b defining the receptacle openings when the manual latch 302 is locked or released such that the protrusions reside inside one or more receptacles of the plurality of receptacles 320. Conversely, when the manual latch 302 is actuated, the protrusions can correspondingly retract out of one or more receptacles to disengage or unlock the manual latch 302 from the rails 106a, 106b.

For instance, as illustrated in FIG. 3A, the securement member 114 can include a hand lock 116 that can be manually actuated by a user to engage and disengage the manual latch 302 from the plurality of receptacles 320 to adjust a seat 102 position. A user can disengage the manual latch 302, according to some examples, by rotating the hand lock 116 that causes the manual latch 302 to correspondingly pivot out of engagement with the rails 106 a, 106b—thus freeing the seat 102 to translate freely on the frame 106. The user can then rotate the hand lock 116 to engage the manual latch and securing the seat 102 in a position. Additionally or alternatively, the user can release the hand lock 116, and the manual latch 302 can automatically pivot back into engagement with the rails 106a, 106b. In one or more examples, the manual latch 302 can include a spring (not illustrated) coupled to the hand lock 116 to assist the user in engaging and/or disengaging the manual latch 302.

FIG. 3B illustrates a perspective view of a securement member 114 of an example creeper 300 in first position 321. In the first position 321, the securement member 114 and associated hand lock 116 can be in an engaged or locked position such that the seat is positionally locked into place. In some examples, and as illustrated in FIG. 3B, the hand lock 116 can be parallel to the rails 106a, 106b when in the first position. Other hand lock positions are herein contemplated, though. For example, the hand lock 116 can be “locked” in an initial, upright position perpendicular to the rails 106a, 106b and then—in response to a user hand actuation—pushed or pulled away from the upright position to actuate the manual latch 302. Similarly, different button configurations, different dial configurations, etc. can be implemented.

FIG. 3C illustrates a perspective view of a securement member 114 of an example creeper 300 in a second position 323. As illustrated in FIG. 3C, the user rotates the hand lock 116 via their hand to disengage the securement member 114. In one or more examples, the hand lock 116 can be operably coupled to the manual latch 302 that engages with the plurality of receptacles 320. As just discussed, the manual latch 302 can include protrusions that can extend into the plurality of receptacles 320 that can secure the seat 102 in position. Then, as the user rotates the hand lock 116 of the securement member 114 to the second position 323, the protrusions can disengage from the plurality of receptacles 320 such that the seat 102 can translate freely along the frame 106. For example, the user can then apply a bodily force to the footrest—which in turn can cause the user seated upon the creeper to move away from the footrest and thus translate the seat 102 and the backrest 104 to a different position along the length of the frame 106. The user can then rotate the hand lock 116 from the second position 323 to the first position 321 to lock the securement member 114 and the seat 102 into the desired position. In this way, the user can adjust the position of the seat 102 and the backrest 104 without getting off of the creeper 300.

Any of the features, components, and/or parts, including the arrangements and configurations thereof shown in FIG. 3A-3C can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 3A-3C.

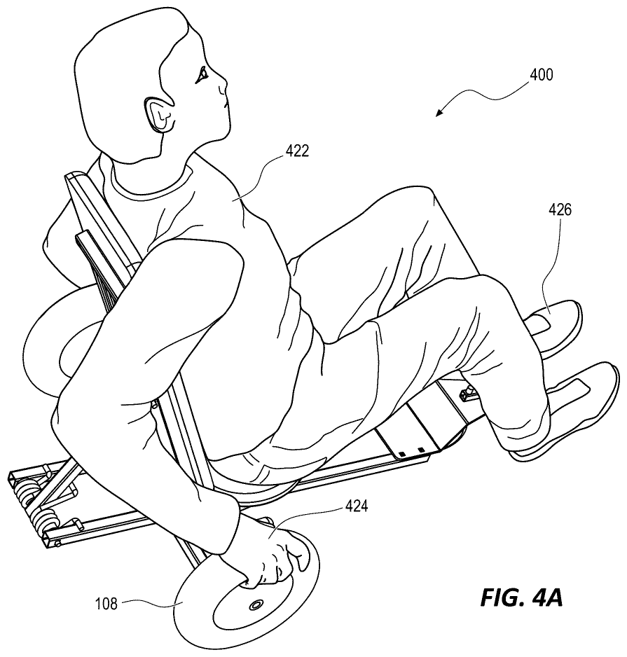

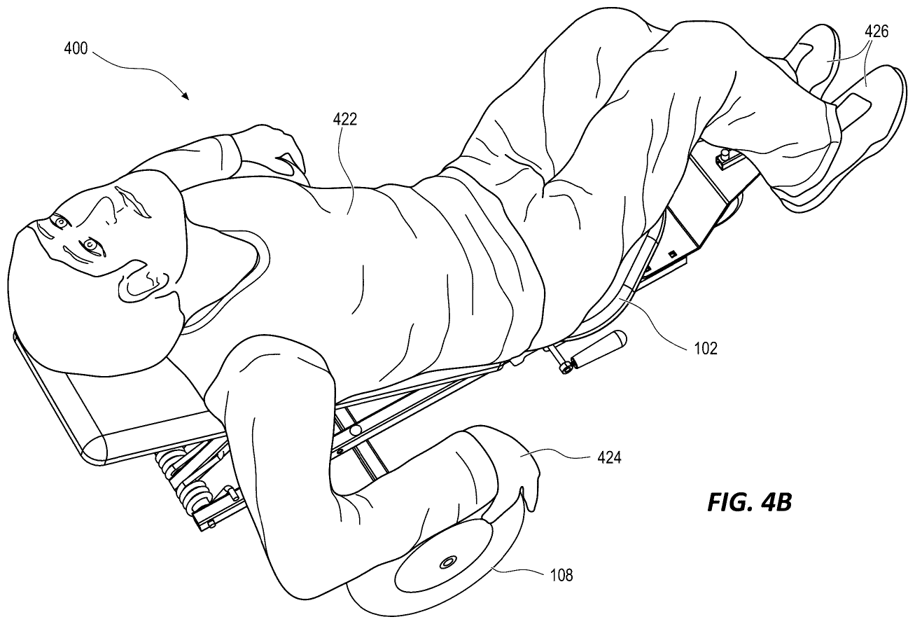

FIG. 4A illustrates a rear isometric view of one example of a user 422 interacting with an example creeper 400. The creeper 400 can be the same as or similar to the creepers 100, 200, 300 discussed above. As illustrated in FIG. 4A, a user 422 can be positioned on the creeper 400 in an upright position (or a partially upright position). In some examples, the user 422 can rest their feet 426 on the footrest such that the user 422 is not in contact with the ground. In other examples, the user 422 can use feet 426 to “walk” the creeper 400 around a worksite—while remaining seated on the creeper 400.

Additional or alternative methods of moving the creeper 400 can be implemented. To illustrate, in one or more examples, the creeper 400 can be maneuvered wheel-chair style. Specifically, the all-terrain wheels 108 can receive manual manipulation from a user 422 to maneuver the creeper 400. In one or more examples, the user's hands 424 can grab the wheels 108 and apply a force to rotate the wheels 108, pivot the wheels 108 to spin the creeper 400 in place, accelerate the wheels 108, pop a front end of the creeper 400 off the ground, etc. For example, the user 422 can apply a force to rotate the wheel 108 like a user 422 would do to move a wheelchair in a particular direction of interest. In this way, the user 422 can maneuver the creeper 400 without getting off the creeper 400, without repositioning, or even without using their legs. In one example, the user 422 can rotate the wheels 108 with their hands 424 to maneuver the creeper 400 over dirt, sand, gravel, or the like.

FIG. 4B illustrates a rear isometric view of one example of a user 422 interacting with an example creeper 400. As illustrated in FIG. 4B, the user 422 can be positioned on the creeper 400 in a reclined position (whether partially raised or completely lowered). In these or other positions, the user 422 can be working under a plane, a tractor, or the like. To exit the creeper 400, or to change from these reclined positions, the user 422 can use the all-terrain wheels 108 as an arm rest or support to the user 422. In particular examples, the user 422 can use the wheels 108 to push off with their arms or hands, thus at least partially unloading the backrest 104. If the securement member 114 is unlocked from the frame 106, the backrest 104 can follow the user's forward lean as the user unloads their weight from the backrest 104 (e.g., due to a mechanically induced return bias). This forward lean or upper torso rising away from the reclined/supine position of the user can be aided by the user 422 utilizing their arms and/or hands to push off the wheels 108. In some examples, pushing off from the wheels 108 can also assist in translating the seat 102 to a desired position.

Any of the features, components, and/or parts, including the arrangements and configurations thereof shown in FIG. 4A-4B can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 4A-4B.

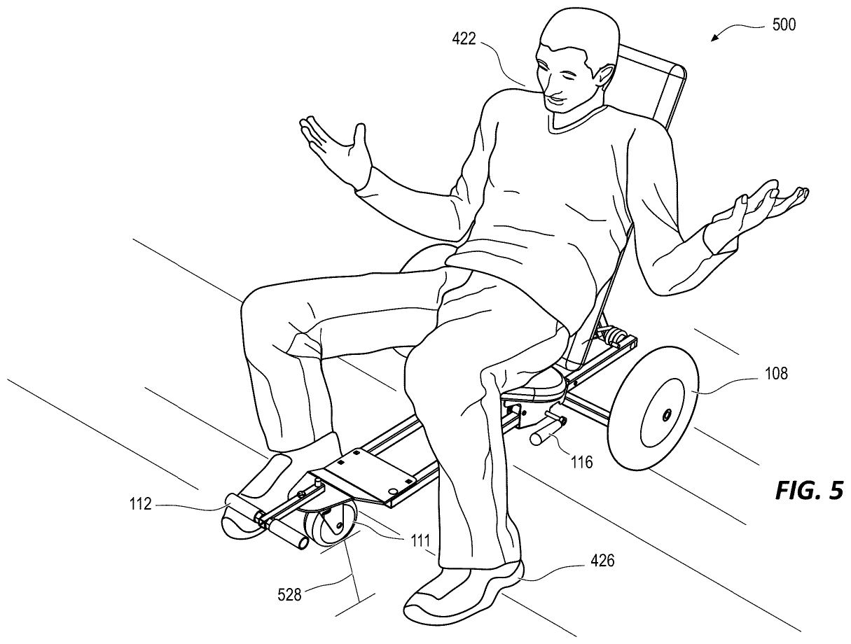

FIG. 5 illustrates an isometric view of one example of a user 422 interacting with an example creeper 500. The creeper 500 can be the same as or similar to the creepers 100, 200, 300, 400 discussed above. In one or more examples, the user 422 can remove their feet 426 from the footrest 112 and place them on the ground. In this example, the user 422 can push off the ground and/or lean back to tilt the creeper 500 and to raise the support 111 off the ground a distance (D) 528. In this way, the user 422 can pivot the creeper 500 using their feet 426. Furthermore, the user 422 can maneuver the creeper 500 on the ground using their feet 426 to propel the creeper 500. For example, in an outdoor environment the support 111 cannot maneuver on the ground type (e.g., dirt, sand, gravel, etc.), therefore, the user 422 can maneuver the creeper 500 with their feet 426 and lifting up the support 111. In some examples, this tilt-back maneuver can be advantageous for more easily traversing large objects or difficult terrain (e.g., steps, curbs, railroad tracks, etc.). Indeed, lifting the support 111 off the ground surface can provide clearance over objects and/or help prevent the support 111 from catching or otherwise impeding creeper motion. In at least one example, (albeit not shown), the creeper 500 can include one or more stops, bumpers, tilt limiters, etc. that can limit the amount of lean-back travel (i.e., the amount of tilt allowed between the ground surface and a rear portion of the frame 106).

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other FIGS. can be included, either alone or in any combination, in the example of the devices, features, components, and parts shown in FIG. 5.

The foregoing description, for purposes of explanation, used specific nomenclature to provide a thorough understanding of the described examples. However, it will be apparent to one skilled in the art—having the benefit of this disclosure—that the specific details are not required in order to practice the described examples. Thus, the foregoing descriptions of the specific examples described herein are presented for purposes of illustration and description. They are not intended to be exhaustive or to limit the examples to the precise forms disclosed.

It will be apparent to one of ordinary skill in the art—having the benefit of this disclosure—that many modifications and variations are possible in view of the above teachings. Indeed, various inventions have been described herein with reference to certain specific aspects and examples. However, with the benefit of this disclosure, those skilled in the art will recognize that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.”

What is claimed is:

1. An adjustable creeper, comprising:
one or more rails;
a seat slidably coupled to the one or more rails;
a backrest rotatably coupled to the seat and the one or more rails to adjust between a raised position and a lowered position; and
wheels coupled to the one or more rails.

2. The adjustable creeper of claim 1, wherein the wheels comprise all-terrain wheels with a diameter of at least 7 inches.

3. The adjustable creeper of claim 1, further comprising a footrest coupled to the one or more rails.

4. The adjustable creeper of claim 3, wherein in an unlocked configuration and while a user is sitting on the seat, the seat is configured to slide along the one or more rails away from the footrest in response to a user pushing against the footrest.

5. The adjustable creeper of claim 1, further comprising a securement member to positionally lock and unlock the seat relative to the one or more rails.

6. The adjustable creeper of claim 5, wherein:
the one or more rails comprise a plurality of receptacles; and
the securement member comprises a manual latch engageable with the plurality of receptacles.

7. The adjustable creeper of claim 6, wherein each receptacle of the plurality of receptacles is spaced apart and corresponds to a seat position along the one or more rails.

8. The adjustable creeper of claim 1, wherein:
the backrest is configured to raise as the seat slides backward along the one or more rails; and
the backrest is configured to lower as the seat slides forward along the one or more rails.

9. The adjustable creeper of claim 1, further comprising a backrest support rotatably coupling the backrest to the one or more rails, wherein the backrest support is biased away from the one or more rails.

10. The adjustable creeper of claim 1, further comprising a support coupled to an end portion of the one or more rails and positionable on a ground surface.

11. The adjustable creeper of claim 10, wherein the support comprises a caster wheel.

12. The adjustable creeper of claim 1, wherein the wheels are configured to receive manual manipulation to maneuver the adjustable creeper.

13. An adjustable creeper, comprising:
a fixed frame;
front and rear ground supports coupled to the fixed frame;
a seat translatable along the fixed frame; and
an adjustable backrest coupled to the seat,
wherein the seat and the adjustable backrest are configured to translate in tandem as the backrest raises and lowers to positionally control a center of mass between the front and rear ground supports.

14. The adjustable creeper of claim 13, wherein to counteract a backward shifting of the center of mass that occurs when a user is progressively reclined in the adjustable creeper, the seat and the adjustable backrest translate forward in tandem to keep the center of mass positioned between the front and rear ground supports.

15. The adjustable creeper of claim 13, wherein to counteract a forward shifting of the center of mass that occurs when a user is progressively uprighted in the adjustable creeper, the seat and the adjustable backrest translate backward in tandem to keep the center of mass closer to the rear ground support than the front ground support.

16. The adjustable creeper of claim 13, wherein the rear ground support comprises a pair of all-terrain wheels.

17. The adjustable creeper of claim 13, wherein the center of mass accounts for a user positioned on the seat during adjustment.

18. The adjustable creeper of claim 13, wherein the backrest is pivotally coupled to the seat at a lower backrest portion and pivotally coupled to the fixed frame at a mid-backrest portion.

19. A manually adjustable creeper, comprising:
a frame;
front and rear ground supports coupled to the frame;
a seat slidably coupled to the frame; and
an adjustable backrest rotatably coupled to the seat,
wherein at least one of the seat or the adjustable backrest are configured for manual user adjustment while a user remains positioned on the seat.

20. The manually adjustable creeper of claim 19, further comprising a footrest coupled to the frame, wherein the manual user adjustment comprises a user applying a bodily force to the footrest to push the seat and the adjustable backrest backward and raise the adjustable backrest.

21. The manually adjustable creeper of claim 19, wherein the manual user adjustment comprises a user applying a bodily force to push off the rear ground supports and at least partially unload the adjustable backrest, the adjustable backrest being spring-loaded to raise upward.

22. The manually adjustable creeper of claim 19, further comprising a hand lock configured to positionally lock or unlock the seat relative to the frame, wherein the manual user adjustment comprises a user applying a hand actuation to the hand lock.

23. An all-terrain adjustable creeper, comprising:
one or more rails;
all-terrain wheels coupled to the one or more rails;
a seat coupled to the one or more rails; and
a backrest rotatable relative to the seat and adjustable between a raised position and a lowered position.
